(19) United States
(12) Patent Application Publication
(10) Pub. No.: US 2023/0208223 A1
(43) Pub. Date: Jun. 29, 2023

(54) MOTOR, COMPRESSOR, AND REFRIGERATION CYCLE APPARATUS

(71) Applicant: Mitsubishi Electric Corporation, Tokyo (JP)

(72) Inventor: Kazuhiko BABA, Tokyo (JP)

(21) Appl. No.: 17/999,272

(22) PCT Filed: Jun. 25, 2020
(86) PCT No.: PCT/JP2020/025006

§ 371 Date: Nov. 18, 2022

(51) Int. Cl. H02K 1/276; H02K 21/16; F25B 31/02

(52) U.S. Cl. CPC H02K 1/276; H02K 21/16; F25B 31/026; H02K 2213/03

(57) ABSTRACT

A motor includes a rotor including a rotor core fixed to a rotary shaft of a compressor, and permanent magnets fixed to the rotor core, and a stator including a stator core surrounding the rotor core from outside in a radial direction about a central axis of the rotary shaft. The rotor core has a first core and a second core in a direction of the central axis. The first core has a hole portion at a center thereof in the radial direction, and has magnet insertion holes located on an outer side of the hole portion in the radial direction. The permanent magnet is inserted in the magnet insertion hole. The permanent magnet constitutes a magnet magnetic pole, and a part of the first core constitutes a pseudo magnetic pole. The second core has a shaft hole at a center thereof in the radial direction. The rotary shaft is fixed to the shaft hole. An inner circumference of the hole portion of the first core is distanced from the rotary shaft in the radial direction. The second core is located on an outer side of the stator core in the direction of the central axis.

### CROSS-REFERENCE TO RELATED APPLICATION

This application is a U.S. National Stage Application of International Application No. PCT/JP2020/025006 filed on Jun. 25, 2020, the contents of which are incorporated herein by reference.

### TECHNICAL FIELD

The present disclosure relates to a motor, a compressor, and a refrigeration cycle apparatus.

### BACKGROUND

A compressor used in a refrigeration cycle apparatus includes a compression mechanism and a motor that drives the compression mechanism. In recent years, the use of a consequent pole motor as the motor of the compressor has been proposed (see, for example, Patent Reference 1).

### PATENT REFERENCE

Patent Reference 1: Japanese Patent Application Publication No.2012-244783 (see FIG. 10)

In the consequent pole motor, magnetic flux tends to leak from the rotor to the rotary shaft. When the magnetic flux leaks to the rotary shaft of the compressor, a part of the compression mechanism may be magnetized, and wear debris may be adsorbed to that part.

### SUMMARY

The present disclosure is intended to solve the above-described problem, and an object of the present disclosure is to reduce magnetic flux leakage from a rotor to a rotary shaft.

A motor according to the present disclosure is a motor used in a compressor, the motor including a rotor including a rotor core fixed to a rotary shaft of the compressor, and a permanent magnet fixed to the rotor core, and a stator including a stator core surrounding the rotor core from outside in a radial direction about a central axis of the rotary shaft. The rotor core has a first core and a second core in a direction of the central axis. The first core has a hole portion at a center thereof in the radial direction, and has a magnet insertion hole located on an outer side of the hole portion in the radial direction. The permanent magnet is inserted in the magnet insertion hole. The permanent magnet constitutes a magnet magnetic pole, and a part of the first core constitutes a pseudo magnetic pole. The second core has a shaft hole at a center thereof in the radial direction, and the rotary shaft is fixed to the shaft hole. An inner circumference of the hole portion of the first core is distanced from the rotary shaft in the radial direction. The second core is located on an outer side of the stator core in the direction of the central axis. The second core is not in contact with the permanent magnet.

According to the present disclosure, the first core to which the permanent magnet is fixed does not contact the rotary shaft, and thus the leakage magnetic flux flowing from the permanent magnet to the rotary shaft can be reduced.

### BRIEF DESCRIPTION OF THE DRAWINGS

FIG. 1 is a longitudinal-sectional view illustrating a compressor of a first embodiment.

FIG. 2 is a longitudinal-sectional view illustrating a motor of the first embodiment.

FIG. 3 is a cross-sectional view illustrating the motor of the first embodiment.

FIG. 4 is a cross-sectional view illustrating a rotor of the first embodiment.

FIG. 5 is a cross-sectional view illustrating a first core of the rotor of the first embodiment.

FIG. 6 is a cross-sectional view illustrating a second core of the rotor of the first embodiment.

FIG. 7(A) is a diagram illustrating a magnet insertion hole in the first core of the first embodiment, and FIG. 7(B) is a diagram illustrating a slit hole in the second core of the first embodiment.

FIG. 8 is a diagram illustrating the dimensions of respective parts in the motor of the first embodiment.

FIG. 9 is a cross-sectional view illustrating a compression mechanism of the first embodiment.

FIG. 10 is a graph illustrating the relationship between (R1−R2)/(R3−R1) and the induced voltage in the first embodiment.

FIG. 11 is a sectional view illustrating a second core of a first modification of the first embodiment.

FIG. 12(A) is a diagram illustrating a magnet insertion hole in a first core of a second modification of the first embodiment, and FIG. 12(B) is a diagram illustrating a slit hole in a second core of the second modification.

FIG. 13(A) is a diagram illustrating a magnet insertion hole in a first core of a third modification of the first embodiment, and FIG. 13(B) is a diagram illustrating a slit hole in a second core of the third modification.

FIG. 14(A) is a diagram illustrating a magnet insertion hole in a first core of a fourth modification of the first embodiment, and FIG. 14(B) is a diagram illustrating a slit hole in a second core of the fourth modification.

FIG. 15 is a longitudinal-sectional view illustrating a motor of a second embodiment.

FIG. 16 is a longitudinal-sectional view illustrating a motor of a third embodiment.

FIG. 17 is a longitudinal-sectional view illustrating a rotor of a fourth embodiment.

FIG. 18 is a longitudinal-sectional view illustrating a rotor of a fifth embodiment.

FIG. 19 is a longitudinal-sectional view illustrating a rotor of a modification of the fifth embodiment.

FIG. 20 is a longitudinal-sectional view illustrating another configuration example of the motor.

FIG. 21 is a diagram illustrating a refrigeration cycle apparatus to which a compressor including the motor of each of the embodiments and the modifications is applicable.

### MODE FOR CARRYING OUT THE INVENTION

### Detailed Description

### (Configuration of Compressor)

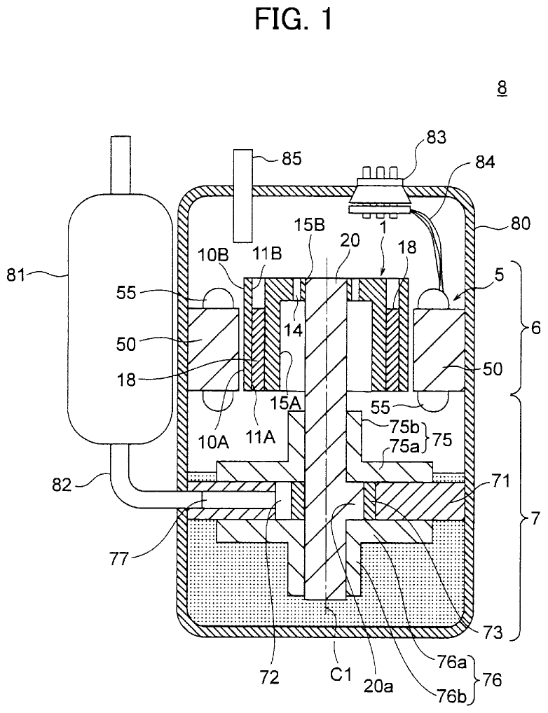

FIG. 1 is a longitudinal-sectional view illustrating a compressor 8 of a first embodiment. The compressor 8 is a rotary compressor. The compressor 8 includes a compression mechanism 7, a motor 6 that drives the compression mechanism 7, a rotary shaft 20 that connects the compression mechanism 7 and the motor 6, and a sealed container 80 that houses these components. Here, the axial direction of the rotary shaft 20 is the vertical direction, and the motor 6 is disposed above the compression mechanism 7.

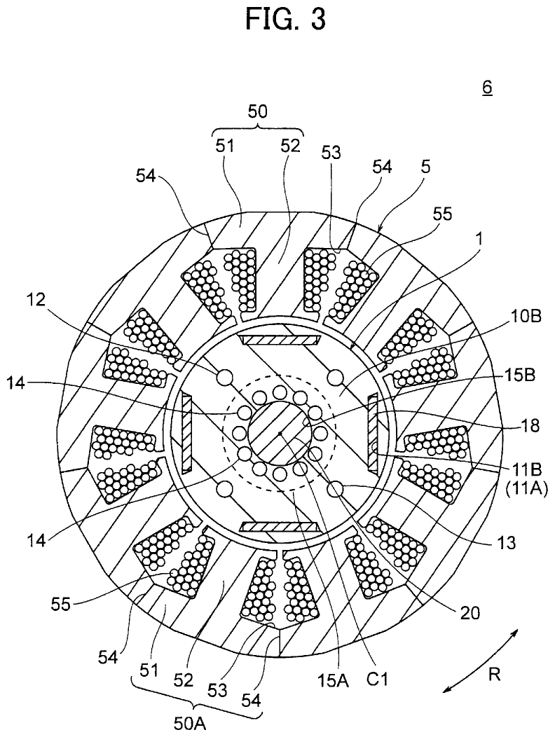

Hereinafter, the direction of a central axis C1, which is the rotation center of the rotary shaft 20, is referred to as an “axial direction”. The radial direction about the central axis C1 is referred to as a “radial direction”, and the circumferential direction (indicated by the arrow R in FIG. 3) about the central axis C1 is referred to as a “circumferential direction”. The sectional view in a plane parallel to the central axis C1 is referred to as a longitudinal-sectional view, whereas the sectional view in a plane perpendicular to the central axis C1 is referred to as a cross-sectional view.

The sealed container 80 is a cylindrical container formed of a steel sheet. A stator 5 of the motor 6 is incorporated inside the sealed container 80 by shrink-fitting, press-fitting, or welding. At the bottom of the sealed container 80, refrigerant oil is stored as a lubricant for lubricating sliding portions of the compression mechanism 7.

The top of the sealed container 80 is provided with a discharge pipe 85 for discharging the refrigerant to the outside and terminals 83 connected to coils 55 of the stator 5 via lead wires 84. The terminals 83 are connected to a control circuit provided outside the compressor 8 and including an inverter. An accumulator 81 that stores a refrigerant gas is attached to the outside of the sealed container 80.

### (Configuration of Motor)

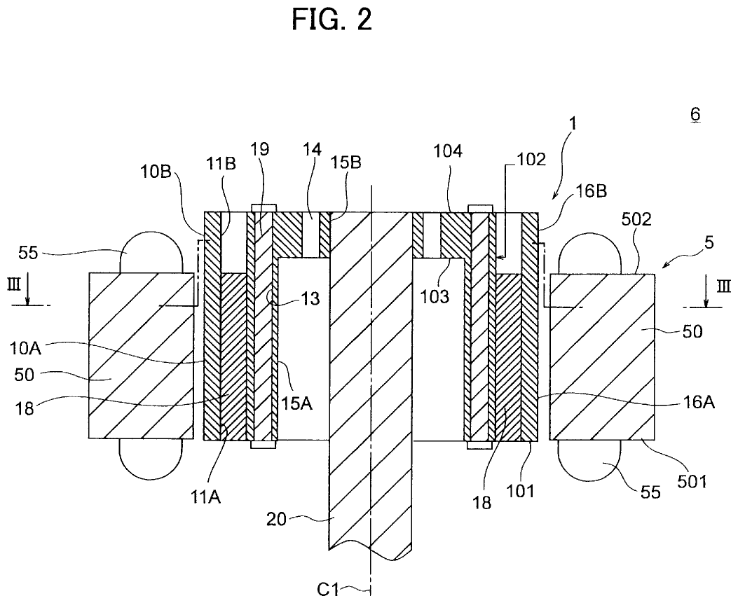

FIG. 2 is a longitudinal-sectional view illustrating the motor 6. FIG. 3 is a sectional view taken along the line illustrated in FIG. 2. The motor 6 includes a rotor 1 fixed to the rotary shaft 20 and the stator 5 surrounding the rotor 1 from outside in the radial direction. A gap of, for example, 0.3 to 1.0 mm is formed between the rotor 1 and the stator 5.

The stator 5 has a stator core 50 and the coils 55 wound on the stator core 50. The stator core 50 is made of a soft magnetic material. More specifically, the stator core 50 is made of a stacked body in which a plurality of electromagnetic steel sheets are stacked. The sheet thickness of each electromagnetic steel sheet is, for example, 0.1 to 0.7 mm.

The outer circumference of the stator core 50 is fit to the inner circumference of the sealed container 80 (FIG. 1). In the axial direction, the stator core 50 has a first end surface 501 facing the compression mechanism 7 (FIG. 1) and a second end surface 502 on a side opposite to the first end surface 501.

As illustrated in FIG. 3, the stator core 50 has a yoke 51 which is annular about the central axis C1 and a plurality of teeth 52 extending inward in the radial direction from the yoke 51. The yoke 51 may be made by combining a plurality of blocks (split cores) divided for each tooth 52, or may be integrally formed in an annular shape.

The teeth 52 are arranged at certain intervals in the circumferential direction. The number of teeth 52 is nine in this example. In this regard, the number of teeth 52 is not limited to nine but only needs to be two or more. A slot 53, which is a space to house the coil 55, is formed between teeth 52 adjacent to each other in the circumferential direction.

The coil 55 is a magnet wire wound around the tooth 52 via an insulating portion. A winding method of the coil 55 is concentrated winding in this example, but may be distributed winding. The insulating portion is made of a resin such as polybutylene terephthalate (PBT), for example.

As illustrated in FIG. 2, the rotor 1 has a rotor core 10 and permanent magnets 18 attached to the rotor core 10. The rotor core 10 is divided into a first core 10A and a second core 10B in the axial direction.

Both the first core 10A and the second core 10B are cylindrical. The first core 10A is located on the compression mechanism 7 side (FIG. 1), while the second core 10B is located on a side opposite to the compression mechanism 7. The first core 10A and the second core 10B will be described in this order.

In the axial direction, the first core 10A has a first end surface 101 facing the compression mechanism 7 (FIG. 1) and a second end surface 102 on a side opposite to the first end surface 101. The first core 10A is made of a soft magnetic material. More specifically, the first core 10A is made of a stacked body in which a plurality of electromagnetic steel sheets are stacked. The sheet thickness of each electromagnetic steel sheet is, for example, 0.1 to 0.7 mm.

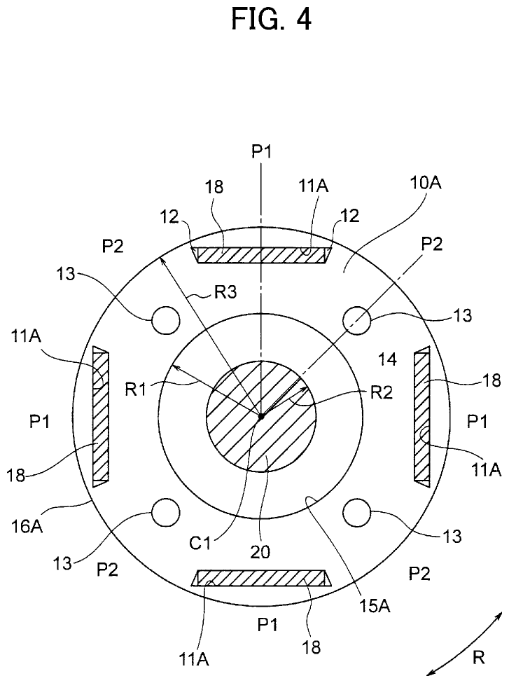

FIG. 4 is a cross-sectional view of the rotor 1 cut in a plane passing through the first core 10A and being perpendicular to the axial direction. The first core 10A has an annular outer circumference 16A, and has a hole portion 15A at its center in the radial direction. Both the outer circumference 16A and the inner circumference of the hole portion 15A are circular about the central axis C1. The inner circumference of the hole portion 15A is distanced from the rotary shaft 20 in the radial direction.

A plurality of magnet insertion holes 11A are formed along the outer circumference 16A of the first core 10A. The magnet insertion holes 11A are arranged at equal intervals in the circumferential direction and also at equal distances from the central axis C1. Each magnet insertion hole 11A extends in the axial direction from the first end surface 101 to the second end surface 102 (FIG. 2) of the first core 10A. The number of magnet insertion holes 11A is four in this example, but is not limited to four. The number of magnet insertion holes 11A only needs to be two or more.

Each magnet insertion hole 11A corresponds to one magnetic pole in this example. The central portion of the magnet insertion hole 11A in the circumferential direction is a pole center. The magnet insertion hole 11A extends linearly in a direction perpendicular to a straight line in the radial direction passing through the pole center, i.e., a magnetic pole center line.

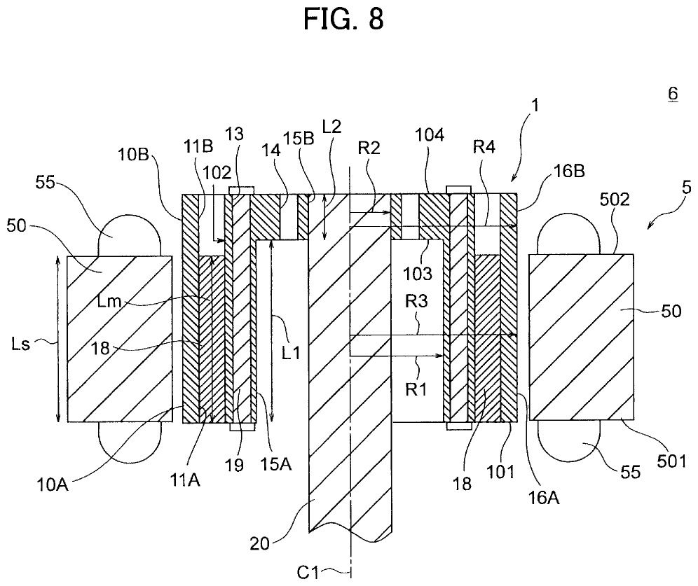

The flat plate-shaped permanent magnet 18 is inserted in each magnet insertion hole 11A. The permanent magnet 18 has a rectangular sectional shape in a plane perpendicular to the axial direction and has a width in the circumferential direction and a thickness in the radial direction. The thickness of the permanent magnet 18 is, for example, 2 mm. A length Lm (FIG. 8) of the permanent magnet 18 in the axial direction is less than or equal to a length Ls (FIG. 8) of the first core 10A in the axial direction.

The permanent magnet 18 is a rare earth magnet and is, more specifically, a neodymium sintered magnet containing Nd (neodymium)-Fe (iron)-B (boron). The permanent magnet 18 is magnetized in its thickness direction.

The permanent magnets 18 are arranged so that the same magnetic poles (for example, the N poles) thereof face the outer circumference 16A side. Consequently, in a region of the first core 10A between the permanent magnets 18 adjacent to each other in the circumferential direction, a magnetic pole (for example, the S pole) opposite to that of the permanent magnets 18 is formed.

That is, the permanent magnets 18 constitute magnet magnetic poles P1 (first magnetic poles), and the first core 10A constitutes pseudo magnetic poles P2 (second magnetic poles). The magnet magnetic poles P1 and the pseudo magnetic poles P2 are alternately arranged in the circumferential direction. This configuration is referred to as a consequent pole type.

In this example, the first core 10A has four magnet magnetic poles P1 and four pseudo magnetic poles P2. That is, the number of poles is eight. The magnetic poles P1 and P2 are arranged at equal angular intervals in the circumferential direction with a pole pitch of 45 degrees (360 degrees/8). Hereinafter, when the term “magnetic pole” is simply used, it indicates either the magnet magnetic pole P1 or the pseudo magnetic pole P2.

Although the number of poles is eight in this example, the number of poles only needs to be an even number of four or more. Further, two or more permanent magnets 18 may be disposed in each magnet insertion hole 11A. Further, the magnet insertion hole 11A may have a V shape, and two or more magnet insertion holes 11A may be provided for one magnetic pole.

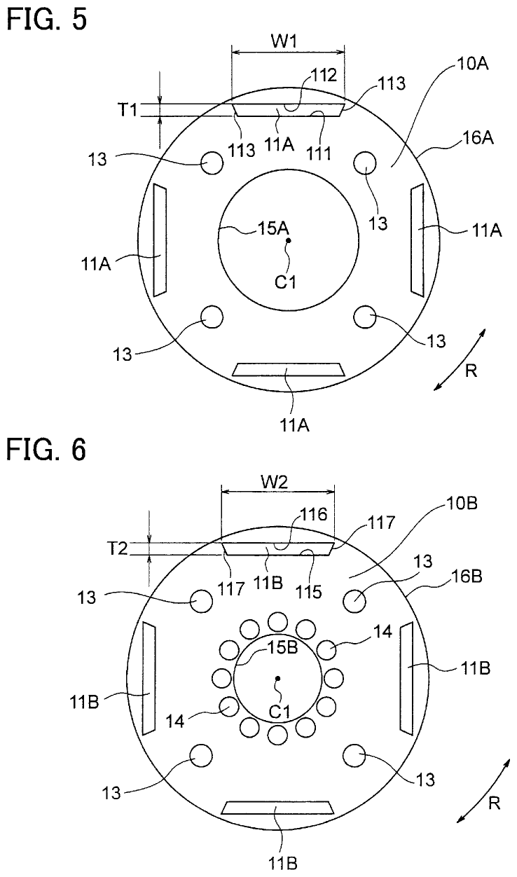

FIG. 5 is a plan view illustrating the first core 10A. The magnet insertion hole 11A has an inner end edge 111 located on the inner side in the radial direction, an outer end edge 112 located on the outer side in the radial direction, and side end edges 113 located on both ends in the circumferential direction. The inner end edge 111 and the outer end edge 112 are parallel to each other. The two side end edges 113 are inclined so that the interval therebetween is larger at the outer side in the radial direction than at the inner side in the radial direction.

A flux barrier 12 (FIG. 4), which is an opening, is formed between the side end edge 113 of the magnet insertion hole 11A and the permanent magnet 18. A thin-walled part is formed between the flux barrier 12 and the outer circumference 16A. In order to reduce leakage magnetic flux between adjacent magnetic poles, the thickness of the thin-walled part is set, for example, equal to the sheet thickness of the electromagnetic steel sheet.

Through holes 13 are formed on the outer side of the hole portion 15A of the first core 10A in the radial direction. Each through hole 13 is a hole through which a rivet 19 is inserted and is also referred to as a rivet hole. In this example, there are provided four through holes 13, the number of which is the same as the number of poles. The four through holes 13 are arranged at equal intervals in the circumferential direction and also at equal distances from the central axis C1. The position of each through hole 13 in the circumferential direction is the same as the position of the pseudo magnetic pole P2 in the circumferential direction. However, the number and arrangement of through holes 13 are not limited to the examples described herein.

The rivet 19 (FIG. 2) is inserted into the through hole 13 to fasten the first core 10A and the second core 10B from both sides thereof in the axial direction. The rivet 19 is desirably made of a nonmagnetic material such as stainless steel. This is to suppress the flow of the magnetic flux from the first core 10A to the second core 10B through the rivet 19.

As illustrated in FIG. 2, in the axial direction, the second core 10B has a first end surface 103 on the first core 10A side and a second end surface 104 on a side opposite to the first end surface 103. The first end surface 103 of the second core 10B is in contact with the second end surface 102 of the first core 10A.

The second core 10B is made of a soft magnetic material. More specifically, the second core 10B is made of a stacked body in which a plurality of electromagnetic steel sheets are stacked. The sheet thickness of each electromagnetic steel sheet is, for example, 0.1 to 0.7 mm.

FIG. 6 is a plan view illustrating the second core 10B. The second core 10B has an annular outer circumference 16B, and has a shaft hole 15B at its center in the radial direction. Both the outer circumference 16B and the inner circumference of the shaft hole 15B are circular about the central axis C1.

The outer diameter of the second core 10B is the same as the outer diameter of the first core 10A. In other words, the outer circumference 16B of the second core 10B is located at the same position in the radial direction as the outer circumference 16A of the first core 10A.

The inner diameter of the shaft hole 15B in the second core 10B is smaller than the inner diameter of the hole portion 15A in the first core 10A. The rotary shaft 20 (FIG. 4) is fitted into the shaft hole 15B of the second core 10B by shrink-fitting or press-fitting.

Since the inner diameter of the shaft hole 15B is smaller than the inner diameter of the hole portion 15A, a part of the first end surface 103 (FIG. 2) of the second core 10B faces a cavity portion inside the hole portion 15A of the first core 10A.

A plurality of slit holes 11B are formed along the outer circumference 16B of the second core 10B. The slit holes 11B are arranged at equal intervals in the circumferential direction and also at equal distances from the central axis C1. Each slit hole 11B extends in the axial direction from the first end surface 103 to the second end surface 104 of the second core 10B (FIG. 2).

The slit holes 11B, the number of which is the same as that of the magnet insertion holes 11A of the first core 10A, are formed at positions that overlap the magnet insertion holes 11A. That is, the slit hole 11B communicates with the magnet insertion hole 11A. In this regard, no permanent magnet 18 (FIG. 4) is inserted in the slit hole 11B.

The slit hole 11B has an inner end edge 115 located on the inner side in the radial direction, an outer end edge 116 located on the outer side in the radial direction, and side end edges 117 located on both ends in the circumferential direction. The end edges 115, 116, and 117 of the slit hole 11B correspond to the end edges 111, 112, and 113 of the magnet insertion hole 11A, respectively.

A plurality of air holes 14 as opening portions are formed on the outer side of the shaft hole 15B of the second core 10B in the radial direction. Each air hole 14 is a passage for the refrigerant in the compressor 8. In this example, 12 air holes 14 are formed at equal intervals in the circumferential direction and also at equal distances from the central axis C1. In this regard, the number of air holes 14 is not limited.

The air holes 14 are desirably disposed close to each other. For example, the distance between adjacent air holes 14, i.e., the width of a core portion between the adjacent air holes 14, is desirably smaller than the diameter of each air hole 14.

The air holes 14 are located on the inner side in the radial direction with respect to the inner circumference of the hole portion 15A in the first core 10A. Thus, the air holes 14 communicate with the cavity portion inside the hole portion 15A of the first core 10A. All the air holes 14 communicate with the cavity portion in this example, but at least one air hole 14 may communicate with the cavity portion.

Since the air holes 14 communicate with the cavity portion inside the first core 10A, the refrigerant flowing from the compression mechanism 7 into the cavity portion inside the first core 10A passes through the air holes 14. The air holes 14 promote separation between the refrigerant and refrigerant oil. Thus, the refrigerant oil is inhibited from flowing to the outside of the compressor 8.

The plurality of air holes 14 are formed around the shaft hole 15B of the second core 10B, and thus the air holes 14 also have the effect of inhibiting the flow of magnetic flux from the second core 10B to the rotary shaft 20.

Through holes 13 are formed on the outer side of the air holes 14 of the second core 10B in the radial direction. Each through hole 13 extends from the first end surface 103 to the second end surface 104 of the second core 10B in the axial direction. The through holes 13 of the second core 10B are located at the same positions as the through holes 13 of the first core 10A in a plane perpendicular to the axial direction.

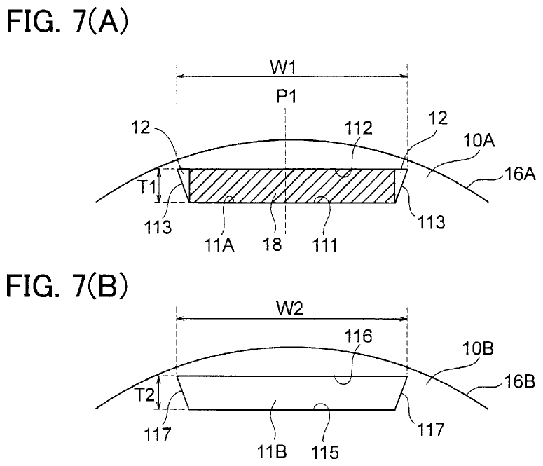

Here, the relationship between the magnet insertion hole 11A and the slit hole 11B will be described. FIG. 7(A) is a schematic diagram for explaining the shape of the magnet insertion hole 11A. FIG. 7(B) is a schematic diagram for explaining the shape of the slit hole 11B.

As illustrated in FIG. 7(A), the magnet insertion hole 11A has a length W1 in the circumferential direction and a width T1 in the radial direction. The length W1 is a length of the outer end edge 112, and the width T1 is a distance between the inner end edge 111 and the outer end edge 112.

As illustrated in FIG. 7(B), the slit hole 11B has a length W2 in the circumferential direction and a width T2 in the radial direction. The length W2 is a length of the outer end edge 116, and the width T2 is a distance between the inner end edge 115 and the outer end edge 116.

The magnet insertion hole 11A and the slit hole 11B desirably have the same shapes and the same dimensions in a plane perpendicular to the axial direction. That is, W1=W2 and T1=T2 are desirably satisfied. In this case, it is possible to prevent the permanent magnet 18 in the magnet insertion hole 11A from coming into contact with a core portion (for example, the first end surface 103) of the second core 10B.

In addition, the length W1 and width T1 of the magnet insertion hole 11A and the length W2 and width T2 of the slit hole 11B may satisfy W2>W1 and T1=T2. Alternatively, W2=W1 and T2>T1 may be satisfied. Alternatively, W2>W1 and T2>T1 may be satisfied.

In other words, W2>W1 and T2>T1 are desirably satisfied. That is, the slit hole 11B desirably has the shape that surrounds the magnet insertion hole 11A from outside in a plane perpendicular to the axial direction. Thus, the permanent magnet 18 in the magnet insertion hole 11A can be prevented from coming into contact with the core portion of the second core 10B, and therefore the flow of magnetic flux from the permanent magnet 18 to the second core 10B can be suppressed.

FIG. 8 is a diagram for explaining the dimensions of respective parts of the rotor 1. The distance from the central axis C1 to the inner circumference of the hole portion 15A of the first core 10A is denoted as a distance R1. The distance from the central axis C1 to the inner circumference of the shaft hole 15B of the second core 10B is denoted as a distance R2.

The distances R1 and R2 satisfy R1>R2. In other words, the inner diameter (R1×2) of the hole portion 15A of the first core 10A is larger than the inner diameter (R2×2) of the shaft hole 15B of the second core 10B.

The distance from the central axis C1 to the outer circumference 16A of the first core 10A is denoted as a distance R3. The distance from the central axis C1 to the outer circumference 16B of the second core 10B is denoted as a distance R4. The distances R3 and R4 satisfy R3=R4. In other words, the outer diameter (R3×2) of the first core 10A is the same as the outer diameter (R4×2) of the second core 10B.

The first core 10A has a length L1 in the axial direction, and the second core 10B has a length L2 in the axial direction. The stator core 50 has a length Ls in the axial direction, and the permanent magnet 18 has a length Lm in the axial direction.

The length L1 of the first core 10A in the axial direction is greater than or equal to the length Ls of the stator core 50 in the axial direction (L1≥Ls). The first end surface 101 of the first core 10A is located at the same position in the axial direction as the first end surface 501 of the stator core 50.

Thus, the first core 10A faces the stator core 50 in the radial direction, while the second core 10B does not face the stator core 50 in the radial direction. In other words, the second core 10B is located so as to protrude from the stator core 50 in the axial direction. Since the magnetic flux flows mainly between the permanent magnet 18 and the stator core 50, the magnetic flux is less likely to flow to the second core 10B because the second core 10B protrudes from the stator core 50 in the axial direction.

The length L1 of the first core 10A in the axial direction is longer than the length L2 of the second core 10B in the axial direction (L1>L2). By making the length L1 of the first core 10A longer, the length of the permanent magnet 18 in the axial direction can be made longer, and high torque can be achieved. Further, by making the length L2 of the second core 10B shorter, the length of the rotor 1 in the axial direction can be shortened, and thus weight reduction can be achieved.

From the above, the lengths L1, L2, and Ls of the first core 10A, the second core 10B and the stator core 50 desirably satisfy L1≥Ls>L2.

The length Lm of the permanent magnet 18 in the axial direction is desirably shorter than the length L1 of the first core 10A in the axial direction. In this case, the permanent magnet 18 is distanced from the second core 10B in the axial direction, and thus the magnetic flux of the permanent magnets 18 is less likely to flow to the second core 10B.

The length Lm of the permanent magnet 18 in the axial direction is desirably less than or equal to the length Ls of the stator core 50 in the axial direction. In this case, the magnetic flux of the permanent magnets 18 can be efficiently interlinked with the stator core 50.

### (Compression Mechanism 7)

Next, the compression mechanism 7 of the compressor 8 will be described. As illustrated in FIG. 1, the compression mechanism 7 has a cylinder 71, a rolling piston 73, a main bearing 75, and an auxiliary bearing 76. The cylinder 71 has a cylindrical cylinder chamber 72 surrounding the rotary shaft 20. The cylinder chamber 72 has an opening on each of the upper and lower ends thereof, and these openings are closed by the main bearing 75 and the auxiliary bearing 76.

The main bearing 75 has a flat plate portion 75a that closes the upper opening of the cylinder chamber 72 and a bearing portion 75b that rotatably supports the rotary shaft 20. The bearing portion 75b is a sliding bearing. The main bearing 75 is made of a magnetic material such as iron and is fixed to an upper surface of the cylinder 71 by bolts or the like.

An upper end of the main bearing 75 is located below the first end surface 101 of the rotor 1. This is to prevent the magnetic flux of the permanent magnets 18 from affecting the main bearing 75 made of the magnetic material.

The auxiliary bearing 76 has a flat plate portion 76a that closes the lower opening of the cylinder chamber 72 and a bearing portion 76b that rotatably supports the rotary shaft 20. The bearing portion 76b is a sliding bearing. The auxiliary bearing 76 is made of a magnetic material such as iron and is fixed to a lower surface of the cylinder 71 by bolts or the like.

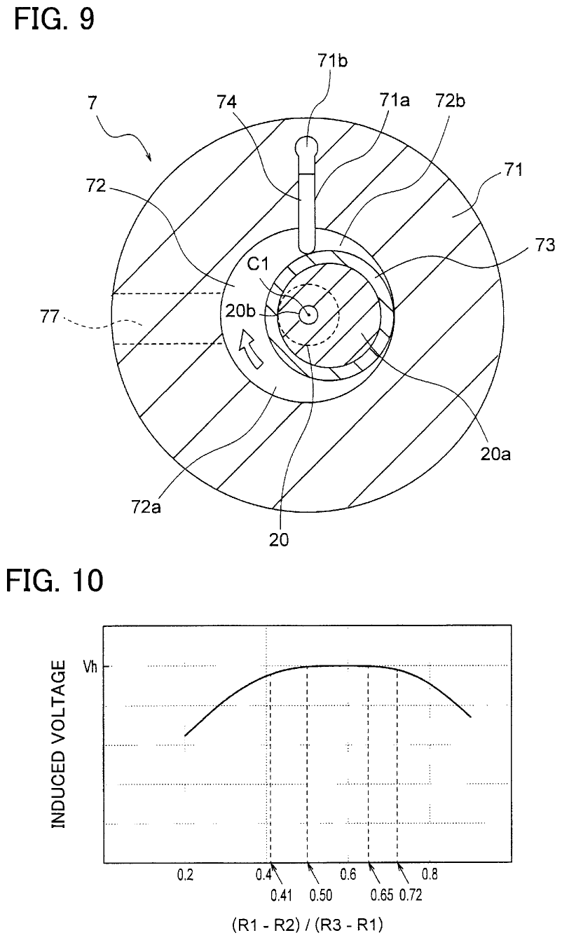

FIG. 9 is a cross-sectional view illustrating the compression mechanism 7. The rotary shaft 20 has an eccentric shaft portion 20a located inside the cylinder chamber 72. The eccentric shaft portion 20a has an eccentric shape with respect to the central axis C1.

The annular rolling piston 73 is fitted to the outer circumference of the eccentric shaft portion 20a. The eccentric shaft portion 20a and the rolling piston 73 rotate in the cylinder chamber 72 by the rotation of the rotary shaft 20.

The rotary shaft 20 is made of a magnetic material such as iron. At the center of the rotary shaft 20, a center hole 20b is formed for supplying the refrigerant oil retained at the bottom of the sealed container 80 to sliding portions of the compression mechanism 7. The center hole 20b is omitted in FIG. 1 described above.

The cylinder 71 is provided with a suction port 77 through which the refrigerant gas is sucked into the cylinder chamber 72 from the outside of the sealed container 80. A suction pipe 82 of the accumulator 81 (FIG. 1) is connected to the suction port 77.

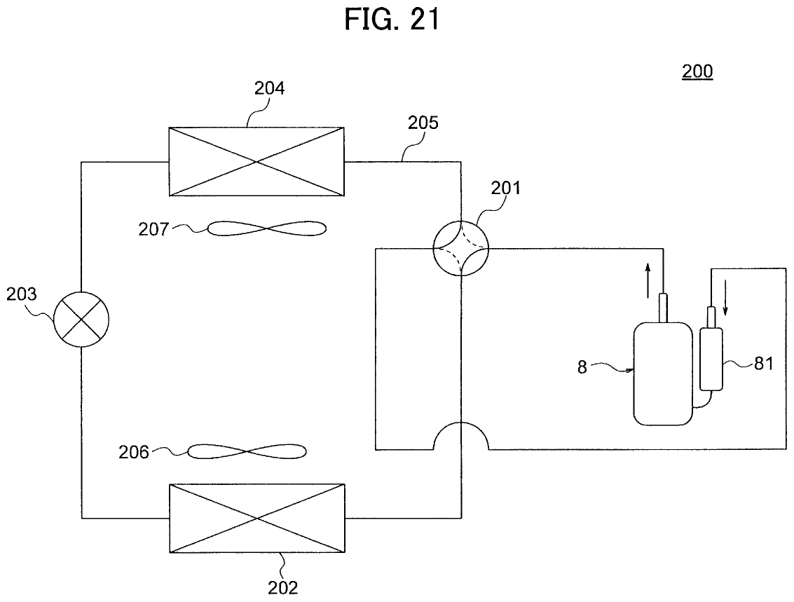

A mixture of a low-pressure refrigerant gas and a liquid refrigerant flows into the accumulator 81 from a refrigerant circuit in a refrigeration cycle apparatus 200 (FIG. 21). The accumulator 81 separates the refrigerant into the liquid refrigerant and the refrigerant gas and supplies only the refrigerant gas to the suction port 77 via the suction pipe 82.

The cylinder 71 has a vane groove 71a extending in the radial direction. One end of the vane groove 71a communicates with the cylinder chamber 72. A back pressure chamber 71b is formed on the other end of the vane groove 71a. A vane 74 is inserted into the vane groove 71a.

The vane 74 can reciprocate within the vane groove 71a. A spring is provided in the back pressure chamber 71b, and presses the vane 74 from the vane groove 71a into the cylinder chamber 72, so that the tip of the vane 74 is brought into contact with an outer circumferential surface of the rolling piston 73.

The vane 74 partitions a space formed by an inner circumferential surface of the cylinder chamber 72 and an outer circumferential surface of the rolling piston 73 into two operation chambers. Of the two operation chambers, one operation chamber that communicates with the suction port 77 functions as a suction chamber into which the low-pressure refrigerant gas is sucked, while the other operation chamber functions as a compression chamber in which the refrigerant is compressed.

The cylinder 71 is provided with a discharge port through which the refrigerant gas compressed in the cylinder chamber 72 is discharged. The main bearing 75 is provided with a discharge opening communicating with the discharge port of the cylinder 71 and a discharge valve. The discharge valve opens when the pressure of the refrigerant gas in the cylinder chamber 72 is higher than or equal to the specified pressure, and causes the refrigerant gas to be discharged into the sealed container 80.

The refrigerant gas discharged from the cylinder chamber 72 into the sealed container 80 flows upward within the sealed container 80. The refrigerant gas flows through the air holes 14 of the rotor 1 in the motor 6 and also through a gap between the rotor 1 and the stator 5, and is discharged through the discharge pipe 85 to the outside.

### (Operation of Compressor)

The operation of the compressor 8 (FIG. 1) is as follows. When current is supplied from the inverter to the coils 55 of the stator 5 via the terminals 83, the attraction force or repulsive force is generated between the stator 5 and the rotor 1 by the magnetic field generated by the current in the coils 55 and the magnetic field of the permanent magnets 18, causing the rotor 1 to rotate. With the rotation of the rotor 1, the rotary shaft 20 fixed to the rotor 1 also rotates.

By the rotation of the rotary shaft 20, the rolling piston 73 attached to the eccentric shaft portion 20a eccentrically rotates in the cylinder chamber 72 as indicated by the arrow in FIG. 9. When the rolling piston 73 eccentrically rotates in the cylinder chamber 72, the operation chamber communicating with the suction port 77 functions as the suction chamber, and sucks a low-pressure refrigerant gas.

The refrigerant gas supplied from the accumulator 81 is supplied through the suction port 77 to the cylinder chamber 72. The refrigerant gas sucked into the cylinder chamber 72 is compressed by the eccentric rotation of the rolling piston 73. The high-pressure refrigerant gas compressed is discharged from the discharge port into the sealed container 80.

The refrigerant gas discharged from the cylinder chamber 72 into the sealed container 80 passes through the air holes 14 of the second core 10B and the gap between the rotor 1 and the stator 5 and rises in the sealed container 80. The refrigerant rising inside the sealed container 80 is discharged through the discharge pipe 85 and sent out to the refrigerant circuit of the refrigeration cycle apparatus 200 (FIG. 21).

Incidentally, the refrigerant oil retained at the bottom of the sealed container 80 is mixed with the refrigerant gas discharged from the compression mechanism 7. If the refrigerant oil is discharged from the compressor 8 together with the refrigerant, the refrigerant oil to be supplied to the compression mechanism 7 may become depleted. A shortage of the refrigeration oil leads to reduced lubrication of the sliding portions of the compression mechanism 7, or inadequate sealing between parts of the compression mechanism 7.

In the present embodiment, when the refrigerant gas discharged from the compression mechanism 7 passes through the air holes 14 in the second core 10B, the separation between the refrigerant gas and the refrigerant oil is promoted. Thus, the refrigerant oil is separated from the refrigerant gas, returns to the bottom of the sealed container 80, and is supplied to the compression mechanism 7. That is, the shortage of the refrigerant oil can be avoided.

### (Operation)

The motor 6 is of a consequent pole type, and the permanent magnet 18 is provided at the magnet magnetic pole P1 (FIG. 4), but no permanent magnet 18 is provided at the pseudo magnetic pole P2 (FIG. 4). The pseudo magnetic pole P2 weakly attracts magnetic flux, as compared to the magnet magnetic pole P1. Thus, the magnetic flux flowing in the rotor core 10 is likely to flow to the rotary shaft 20.

When the magnetic flux flows to the rotary shaft 20, a part of the compression mechanism 7 (FIG. 1) in contact with the rotary shaft 20 may be magnetized. For example, the main bearing 75 or auxiliary bearing 76 may be magnetized because it is made of a magnetic material and is in contact with the rotary shaft 20. When a part of the compression mechanism 7 is magnetized in this way, wear debris are likely to be adsorbed to the part, and the operating resistance of the compression mechanism 7 may increase.

As illustrated in FIG. 2, in the present embodiment, the rotor core 10 has the first core 10A and the second core 10B, and the permanent magnet 18 is fixed to the first core 10A, while the rotary shaft 20 is fixed to the second core 10B. Further, the inner circumference of the hole portion 15A of the first core 10A is distanced from the rotary shaft 20.

Since the first core 10A with the permanent magnets 18 fixed thereto is distanced from the rotary shaft 20, the magnetic flux of the permanent magnets 18 is less likely to flow to the rotary shaft 20. Thus, the magnetic flux leakage to the rotary shaft 20 can be reduced, and therefore the adsorption of wear debris to the compression mechanism 7 can be prevented.

The second core 10B has the slit hole 11B communicating with the magnet insertion hole 11A of the first core 10A. As illustrated in FIGS. 7(A) and 7(B), the length W1 and width T1 of the magnet insertion hole 11A and the length W2 and width T2 of the slit hole 11B satisfy W2>W1 and T2>T1. Thus, the permanent magnet 18 in the magnet insertion hole 11A can be prevented from coming into contact with the core portion of the second core 10B, and therefore the flow of magnetic flux from the permanent magnet 18 to the second core 10B can be suppressed.

In particular, when W1=W2 and T1=T2 are satisfied and the outer diameter of the first core 10A is the same as the outer diameter of the second core 10B, the electromagnetic steel sheets constituting the first core 10A and the electromagnetic steel sheets constituting the second core 10B can be formed in the same shape, except for the hole portion 15A and the shaft hole 15B. Thus, the manufacturing process can be simplified, and therefore manufacturing cost can be reduced.

Here, the relationship among the distances R1, R2, and R3 illustrated in FIG. 8 will be described. As described above, the distance R1 is a distance from the central axis C1 to the inner circumference of the hole portion 15A of the first core 10A. The distance R2 is a distance from the central axis C1 to the inner circumference of the shaft hole 15B of the second core 10B. The distance R3 is a distance from the central axis C1 to the outer circumference 16A of the first core 10A.

Since the rotary shaft 20 is fitted to the shaft hole 15B of the second core 10B, the radius of the rotary shaft 20 can be considered to be the same as the distance R2.

A difference between the distance R1 and the distance R2 (R1−R2) corresponds to the shortest distance from the rotary shaft 20 to the first core 10A. Meanwhile, a difference between the distance R3 and the distance R1 (R3−R1) corresponds to the width of the first core 10A in the radial direction, i.e., the width of the magnetic path.

As R1−R2 increases, the first core 10A is more distanced from the rotary shaft 20, and thus magnetic flux leakage from the first core 10A to the rotary shaft 20 is less likely to occur. However, since the strength of the rotary shaft 20 needs to be secured, there is a limit to decreasing the distance R2, which is the radius of the rotary shaft 20. Thus, in order to increase R1−R2, it is necessary to increase the distance R1.

On the other hand, if the distance R1 is increased, R3−R1 decreases, and the width of the first core 10A in the radial direction decreases. Thus, magnetic saturation may occur in the first core 10A, and an induced voltage may decrease. The reduction in the induced voltage leads to a reduction in the motor efficiency and output.

Therefore, the distances R1, R2, and R3 described above are determined so as not to cause the magnetic saturation in the first core 10A while reducing the magnetic flux leakage to the rotary shaft 20.

Thus, attention is focused on (R1−R2)/(R3−R1), which is the ratio of (R1−R2) to (R3−R1). How the induced voltage changes when the value of (R1−R2)/(R3−R1) is varied is analyzed through simulation. The induced voltage is a voltage induced in the coil 55 of the stator 5 by the magnetic field of the permanent magnet 18 when the rotor 1 rotates. As the induced voltage increases, higher motor efficiency can be obtained.

FIG. 10 is a graph illustrating the relationship between (R1−R2)/(R3−R1) and the induced voltage. The horizontal axis represents (R1−R2)/(R3−R1), and the vertical axis represents the induced voltage expressed as a relative value. On the vertical axis, the maximum value of the induced voltage is denoted by Vh. The curve in FIG. 10 indicates the result of analyzing the change in the induced voltage by simulation in which both the distances R2 and R3 are set to fixed values and the value of the distance R1 is varied.

As can be seen from FIG. 10, the induced voltage is low when (R1−R2)/(R3−R1) is small. This is because the magnetic flux leakage from the first core 10A to the rotary shaft 20 is more likely to occur when R1−R2 is small, that is, when the distance between the rotary shaft 20 and the first core 10A is short.

In contrast, as (R1−R2)/(R3−R1) increases, the induced voltage also increases. When (R1−R2)/(R3−R1) is greater than or equal to 0.41, an increase in the induced voltage starts to saturate. This is because the distance between the rotary shaft 20 and the first core 10A (i.e., R1−R2) is long enough to inhibit the magnetic flux leakage to the rotary shaft 20, and the width of the magnetic path of the first core 10A (i.e., R3−R1) is not extremely narrow. The point where (R1−R2)/(R3−R1) is 0.41 in the curve illustrated in FIG. 10 corresponds to an inflection point.

In the range of (R1−R2)/(R3−R1) from 0.50 or more and 0.65 or less, an increase in the induced voltage reaches the saturated state, and the highest induced voltage is obtained. This is because this range ensures that the distance between the rotary shaft 20 and the first core 10A is long enough to reduce the magnetic flux leakage to the rotary shaft 20 and also ensures that the width of the magnetic path in the first core 10A is enough to effectively utilize the magnetic flux of the permanent magnets 18.

If (R1−R2)/(R3−R1) is greater than 0.72, the induced voltage decreases. This is because R3−R1 is small, that is, the magnetic path in the first core 10A is narrow, and thus the magnetic saturation occurs inside the first core 10A and a part of the magnetic flux of the permanent magnets 18 cannot be effectively utilized. The point where (R1−R2)/(R3−R1) is 0.72 in the curve illustrated in FIG. 10 corresponds to an inflection point.

From the above described results, it is understood that when (R1−R2)/(R3−R1) is 0.41 or more and 0.72 or less, the magnetic flux leakage to the rotary shaft 20 is reduced and high motor efficiency can be achieved.

Further, when (R1−R2)/(R3−R1) is 0.50 or more and 0.65 or less, the magnetic flux leakage to the rotary shaft 20 is reduced most effectively and the highest motor efficiency can be obtained.

### Effects of Embodiment

As described above, in the motor 6 of the first embodiment, the rotor core 10 has the first core 10A and the second core 10B in the axial direction, and the first core 10A has the hole portion 15A and the magnet insertion holes 11A. The permanent magnets 18 in the magnet insertion hole 11A form the magnet magnetic poles P1, while the first core 10A forms the pseudo magnetic poles P2. The second core 10B has, at its center in the radial direction, the shaft hole 15B to which the rotary shaft 20 is fixed, and the inner circumference of the hole portion 15A of the first core 10A is distanced from the rotary shaft 20 in the radial direction. The second core 10B is located on the outer side of the stator core 50 in the axial direction.

As above, the permanent magnets 18 are fixed to the first core 10A, the rotary shaft 20 is fixed to the second core 10B, and the inner circumference of the hole portion 15A of the first core 10A is distanced from the rotary shaft 20. Thus, the magnetic flux of the permanent magnets 18 is less likely to flow to the rotary shaft 20. Therefore, the magnetic flux leakage to the rotary shaft 20 can be reduced. This can suppress the adsorption of wear debris caused by the magnetization of the compression mechanism 7.

The length L1 of the first core 10A in the axial direction, the length L2 of the second core 10B in the axial direction, and the length Ls of the stator core 50 in the axial direction satisfy L1≥Ls>L2. Thus, the second core 10B can be disposed outside a region where the magnetic flux flows most, and therefore the magnetic flux is likely to flow in the second core 10B.

The second core 10B has the slit holes 11B communicating with the magnet insertion holes 11A of the first core 10A. Thus, the magnetic flux of the permanent magnets 18 is less likely to flow to the second core 10B, and therefore the effect of suppressing the magnetic flux leakage to the rotary shaft 20 can be enhanced.

In particular, the length W1 in the circumferential direction and the width T1 in the radial direction of the magnet insertion hole 11A and the length L2 in the circumferential direction and the width T2 in the radial direction of the slit hole 11B satisfy W2≥W1 and T2≥T1. Thus, it is possible to prevent the permanent magnet 18 in the magnet insertion hole 11A from coming into contact with the core portion of the second core 10B, and therefore the effect of reducing the magnetic flux leakage to the rotary shaft 20 can be enhanced.

When the first core 10A and the second core 10B have the same outer diameter, and the length W1 and width T1 of the magnet insertion hole 11A and the length L2 and width T2 of the slit hole 11B satisfy W2=W1 and T2=T1, the shape of the electromagnetic steel sheet of the first core 10A and the shape of the electromagnetic steel sheet of the second core 10B are similar for the most part. Thus, the manufacturing cost can be reduced.

Since the through hole 13 penetrates the first core 10A and the second core 10B in the axial direction, the through hole 13 is used as a rivet hole, so that the first core 10A and the second core 10B can be fastened together.

The second core 10B has the plurality of air holes 14 around the shaft hole 15B, and the magnetic flux is less likely to flow from the second core 10B to the rotary shaft 20. Since at least one air hole 14 communicates with the cavity portion inside the hole portion 15A of the first core 10A, the separation between the refrigerant and the refrigerant oil can be promoted by the air hole 14.

The distance R1 from the central axis C1 to the inner circumference of the hole portion 15A of the first core 10A, the distance R2 from the central axis C1 to the inner circumference of the shaft hole 15B of the second core 10B, and the distance R3 from the central axis C1 to the outer circumference 16A of the first core 10A satisfy 0.41≤(R1−R2)/(R3−R1)≤0.72. Thus, the magnetic flux leakage to the rotary shaft 20 can be reduced, and high motor efficiency can be achieved.

When the distances R1, R2, and R3 satisfy 0.50≤(R1−R2)/(R3−R1)≤0.65, the magnetic flux leakage to the rotary shaft 20 can be especially reduced, and thus high motor efficiency can be achieved.

### First Modification

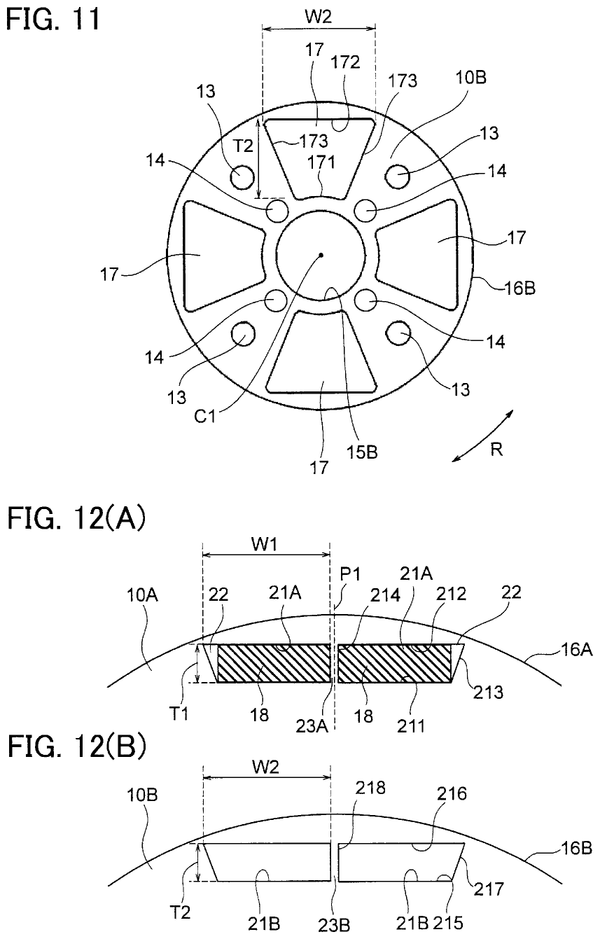

FIG. 11 is a diagram illustrating a second core 10B of a first modification of the first embodiment. In the second core 10B of the first modification, the shapes of slit holes 17 differ from those of the slit holes 11B (FIG. 6) of the first embodiment.

The slit hole 17 has an inner end edge 171 located on the inner side in the radial direction, an outer end edge 172 located on the outer side in the radial direction, and side end edges 173 located on both sides in the circumferential direction. The outer end edge 172 corresponds to the outer end edge 112 of the magnet insertion hole 11A (FIG. 5). The inner end edge 171 is formed at the same position in the radial direction as that of the air hole 14 and extends in an arc shape along the shaft hole 15B. Each side end edge 173 extends linearly in the radial direction.

The length W2 of the slit hole 17 in the circumferential direction, i.e., the length of the outer end edge 172, is greater than or equal to the length W1 of the magnet insertion hole 11A (FIG. 7(A)). The width T2 of the slit hole 17 in the radial direction, i.e., the distance between the inner end edge 171 and the outer end edge 172, is wider than the width T1 of the magnet insertion hole 11A (FIG. 7(A)).

One through hole 13 and one air hole 14 are formed between slit holes 17 adjacent to each other in the circumferential direction. Each of the through hole 13 and the air hole 14 is formed at a position in the circumferential direction that corresponds to the pseudo magnetic pole P2. Incidentally, two or more through holes 13 or two or more air holes 14 may be formed between the slit holes 17 adjacent to each other in the circumferential direction.

Since the slit holes 17 are provided as above, the permanent magnets 18 (FIG. 7(A)) in the magnet insertion holes 11A can be prevented from coming into contact with the core portion of the second core 10B, and thus the flow of magnetic flux from the permanent magnets 18 to the second core 10B can be suppressed. Since the area of the slit holes 17 is large and the area of portions serving as the magnetic paths in the second core 10B is small, the magnetic flux is less likely to flow from the second core 10B to the rotary shaft 20. Thus, the effect of reducing the magnetic flux leakage can be enhanced.

### Second Modification

FIG. 12(A) is a schematic diagram illustrating magnet insertion holes 21A of a first core 10A of a second modification. FIG. 12(B) is a schematic diagram illustrating slit holes 21B of a second core 10B of the second modification.

As illustrated in FIG. 12(A), two magnet insertion holes 21A are provided for each magnetic pole in the first core 10A, and a bridge 23A is formed between the magnet insertion holes 21A. The two magnet insertion holes 21A are arranged side by side linearly in a direction perpendicular to the magnetic pole center line. One permanent magnet 18 is inserted in each magnet insertion hole 21A.

Each magnet insertion hole 21A has an inner end edge 211 located on the inner side in the radial direction, an outer end edge 212 located on the outer side in the radial direction, a side end edge 213 located on the outer side in the circumferential direction, and a side end edge 214 located on the bridge 23A side. The inner end edge 211 and the outer side end edge 212 extend in the direction perpendicular to the magnetic pole center line. The side end edge 213 is inclined such that a distance from the magnetic pole center line increases outward in the radial direction. A flux barrier 22 is formed on the side end edge 213 side of each magnet insertion hole 21A.

The magnet insertion hole 21A has a length W1 in the circumferential direction and a width T1 in the radial direction. The length W1 is a length of the outer end edge 212, and the width T1 is a distance between the inner end edge 211 and the outer end edge 212.

As illustrated in FIG. 12(B), the second core 10B is provided with two slit holes 21B corresponding to two magnet insertion holes 21A, and a bridge 23B is formed between the two slit holes 21B. Each slit hole 21B is formed at a position that overlaps the magnet insertion hole 21A.

Each slit hole 21B has an inner end edge 215 located on the inner side in the radial direction, an outer end edge 216 located on the outer side in the radial direction, a side end edge 217 located on the outer side in the circumferential direction, and a side end edge 218 located on the bridge 23B side. These end edges 215, 216, 217, and 218 correspond to the end edges 211, 212, 213, and 214 of the magnet insertion hole 21A, respectively.

The slit hole 21B has a length W2 in the circumferential direction and a width T2 in the radial direction. The length W2 is a length of the outer end edge 216, and the width T2 is a distance between the inner end edge 215 and the outer end edge 216.

The length W1 and width T1 of the magnet insertion hole 21A and the length W2 and width T2 of the slit hole 21B satisfy W2≥W1 and T2≥T1. Thus, the permanent magnet 18 in the magnet insertion hole 11A can be prevented from coming into contact with the core portion of the second core 10B, and therefore the flow of magnetic flux from the permanent magnet 18 to the second core 10B can be suppressed.

Incidentally, the slit hole 21B does not necessarily have the same shape as the magnet insertion hole 21A. The slit hole 21B may have a shape that surrounds the magnet insertion hole 21A from outside in a plane perpendicular to the axial direction. For example, the two slit holes 21B illustrated in FIG. 12(B) may constitute one continuous slit hole instead of being divided by the bridge 23B.

### Third Modification

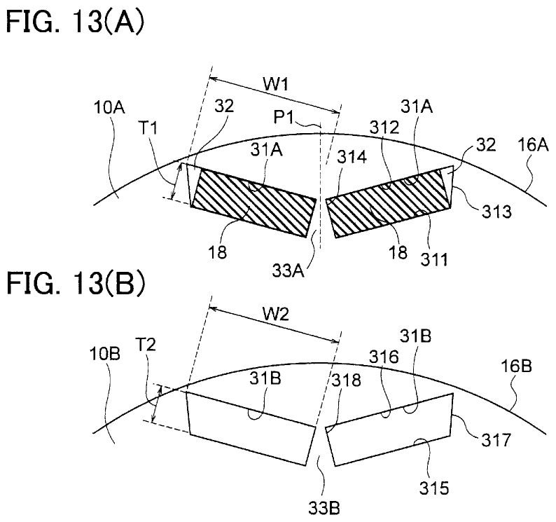

FIG. 13(A) is a schematic diagram illustrating magnet insertion holes 31A of a first core 10A of a third modification. FIG. 13(B) is a schematic diagram illustrating slit holes 31B of a second core 10B of the third modification.

As illustrated in FIG. 13(A), two magnet insertion holes 31A are provided for each magnetic pole in the first core 10A, and a bridge 33A is formed between the magnet insertion holes 31A. The two magnet insertion holes 31A are arranged to form a V shape such that the pole center sides thereof protrude inward in the radial direction. One permanent magnet 18 is inserted in each magnet insertion hole 31A.

The magnet insertion hole 31A has an inner end edge 311 located on the inner side in the radial direction, an outer end edge 312 located on the outer side in the radial direction, a side end edge 313 located on the outer side in the circumferential direction, and a side end edge 314 located on the bridge 33A side. The inner end edge 311 and the outer end edge 312 are parallel to each other and each extend at an inclination with respect to the magnetic pole center line. The side end edge 313 extends in parallel to the magnetic pole center line. A flux barrier 32 is formed on the side end edge 313 side of each magnet insertion hole 31A.

Each magnet insertion hole 31A has a length W1 in the circumferential direction and a width T1 in the radial direction. The length W1 is a length of the outer end edge 312, and the width T1 is a distance between the inner end edge 311 and the outer end edge 312.

As illustrated in FIG. 13(B), the second core 10B is provided with two slit holes 31B corresponding to the two magnet insertion holes 31A, and a bridge 33B is formed between the two slit holes 31B. Each slit hole 31B is formed at a position that overlaps the magnet insertion hole 31A.

The slit hole 31B has an inner end edge 315 located on the inner side in the radial direction, an outer end edge 316 located on the outer side in the radial direction, a side end edge 317 located on the outer side in the circumferential direction, and a side end edge 318 located on the bridge 33B side. These end edges 315, 316, 317, and 318 correspond to the end edges 311, 312, 313, and 314 of the magnet insertion hole 31A, respectively.

Each slit hole 31B has a length W2 in the circumferential direction and a width T2 in the radial direction. The length W2 is a length of the outer end edge 316, and the width T2 is a distance between the inner end edge 315 and the outer end edge 316.

The length W1 and width T1 of the magnet insertion hole 31A and the length W2 and width T2 of the slit hole 31B satisfy W2≥W1 and T2≥T1. Thus, the permanent magnet 18 in the magnet insertion hole 11A can be prevented from coming into contact with the core portion of the second core 10B, and therefore the flow of magnetic flux from the permanent magnet 18 to the second core 10B can be suppressed.

Incidentally, the slit hole 31B does not necessarily have the same shape as the magnet insertion hole 31A. The slit hole 31B may have a shape that surrounds the magnet insertion hole 31A from outside in a plane perpendicular to the axial direction. For example, the two slit holes 31B illustrated in FIG. 13(B) may constitute one continuous V-shaped slit hole instead of being divided by the bridge 33B.

### Fourth Modification

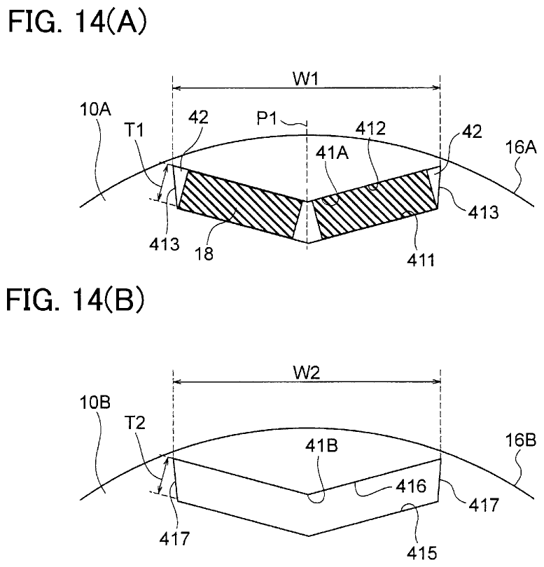

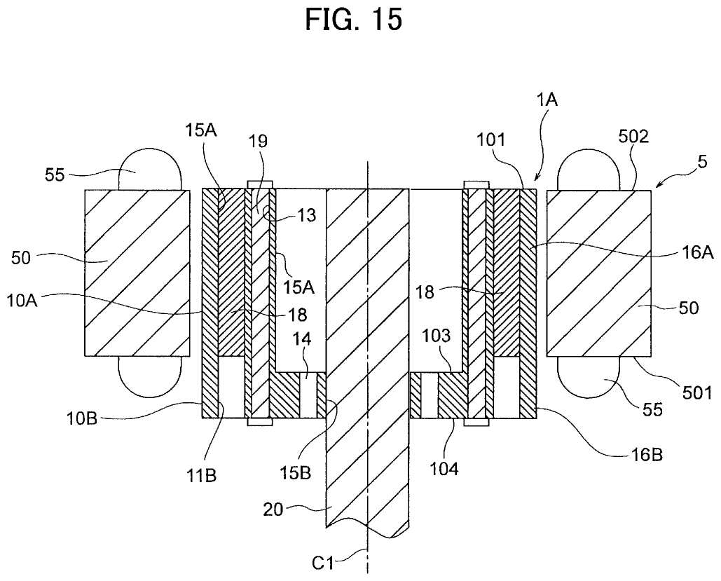

FIG. 14(A) is a schematic diagram illustrating a magnet insertion hole 41A of a first core 10A of a fourth modification. FIG. 14(B) is a schematic diagram illustrating a slit hole 41B of a second core 10B of the fourth modification.

As illustrated in FIG. 14(A), one magnet insertion hole 41A is provided for each magnetic pole in the first core 10A. The magnet insertion hole 41A has a V shape such that the pole center protrudes inward in the radial direction. Two permanent magnets 18 are inserted in each magnet insertion hole 41A.

The magnet insertion hole 41A has an inner end edge 411 located on the inner side in the radial direction, an outer end edge 412 located on the outer side in the radial direction, and side end edges 413 located on both sides in the circumferential direction. Both the inner end edge 411 and the outer end edge 412 extend in the V-shape and are parallel to each other. The side end edges 413 extend in parallel to the magnetic pole center line. A flux barrier 42 is formed on each side end edge 413 side of the magnet insertion hole 41A.

The magnet insertion hole 41A has a length W1 in the circumferential direction and a width T1 in the radial direction. The length W1 is a distance between both ends of the outer end edge 412, and the width T1 is a distance between the inner end edge 411 and the outer end edge 412.

As illustrated in FIG. 14(B), the second core 10B is provided with the slit hole 41B corresponding to the magnet insertion hole 41A. The slit hole 41B is formed at a position that overlaps the magnet insertion hole 41A.

The slit hole 41B has an inner end edge 415 located on the inner side in the radial direction, an outer end edge 416 located on the outer side in the radial direction, and side end edges 417 located on both sides in the circumferential direction. These end edges 415, 416, and 417 correspond to the end edges 411, 412, and 413 of the magnet insertion hole 41A, respectively.

Each slit hole 41B has a length W2 in the circumferential direction and a width T2 in the radial direction. The length W2 is a distance between both ends of the outer end edge 416, and the width T2 is a distance between the inner end edge 415 and the outer end edge 416.

The length W1 and width T1 of the magnet insertion hole 41A and the length W2 and width T2 of the slit hole 41B satisfy W2≥W1 and T2≥T1. Thus, the permanent magnet 18 in the magnet insertion hole 11A can be prevented from coming into contact with the core portion of the second core 10B, and therefore the flow of magnetic flux from the permanent magnet 18 to the second core 10B can be suppressed.

Incidentally, the slit hole 41B does not necessarily have the same shape as the magnet insertion hole 41A. The slit hole 41B may have a shape that surrounds the magnet insertion hole 41A from outside in a plane perpendicular to the axial direction.

Second Embodiment

FIG. 15 is a longitudinal-sectional view illustrating a motor of a second embodiment. The motor of the second embodiment differs from the motor 6 of the first embodiment in that a second core 10B of a rotor 1A is disposed on the compression mechanism 7 side (FIG. 1), i.e., on the lower side in FIG. 15.

The second core 10B is located at a position protruding from the stator core 50 toward the compression mechanism 7 side (FIG. 1). More specifically, a first end surface 103 of the second core 10B is located on the compression mechanism 7 side with respect to the first end surface 501 of the stator core 50.

The first core 10A faces the stator core 50 in the radial direction. The permanent magnets 18 are inserted in the magnet insertion holes 11A of the first core 10A. Each permanent magnet 18 is located between both the end surfaces 501 and 502 of the stator core 50 in the axial direction.

The second core 10B has the slit holes 11B communicating with the first cores 10A. The magnet insertion holes 11A and the slit holes 11B are as described in the first embodiment. It is also possible to provide the magnet insertion holes and the slit holes described in the first to fourth modifications.

The motor of the second embodiment is configured in a similar manner to the motor 6 of the first embodiment in other respects.

Also in the motor of the second embodiment, the permanent magnets 18 are fixed to the first core 10A, the rotary shaft 20 is fixed to the second core 10B, and the inner circumference of the hole portion 15A of the first core 10A is distanced from the rotary shaft 20. Thus, the magnetic flux of the permanent magnets 18 is less likely to flow to the rotary shaft 20, and the magnetic flux leakage to the rotary shaft 20 can be reduced.

### Third Embodiment

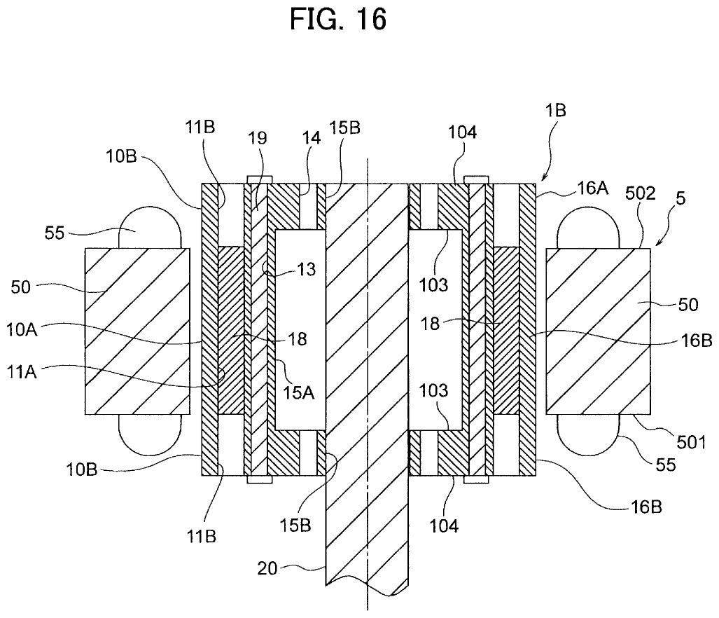

FIG. 16 is a longitudinal-sectional view illustrating a motor of a third embodiment. The motor of the third embodiment differs from the motor 6 of the first embodiment in that two second cores 10B are provided on both sides in the axial direction of the first core 10A of a rotor 1B.

One of the second cores 10B is located at a position protruding from the stator core 50 toward the compression mechanism 7 side (FIG. 1). The first end surface 103 of this second core 10B is located on the compression mechanism 7 side (FIG. 1) with respect to the first end surface 501 of the stator core 50.

The other of the second cores 10B is located at a position protruding from the stator core 50 toward the side opposite to the compression mechanism 7 (FIG. 1). The first end surface 103 of this second core 10B is located on the side opposite to the compression mechanism 7 (FIG. 1) with respect to the second end surface 502 of the stator core 50.

The first core 10A faces the stator core 50 in the radial direction. The permanent magnets 18 are inserted in the magnet insertion holes 11A of the first core 10A. Each permanent magnet 18 is located between both end surfaces 501 and 502 of the stator core 50 in the axial direction.

Each of the second cores 10B has the slit holes 11B communicating with the magnet insertion holes 11A of the first core 10A. The magnet insertion holes 11A and the slit holes 11B are as described in the first embodiment. It is also possible to provide the magnet insertion holes and the slit holes described in the first to fourth modifications.

The motor of the third embodiment is configured in a similar manner to the motor 6 of the first embodiment in other respects.

Also in the motor of the third embodiment, as in the motor 6 of the first embodiment, the magnetic flux of the permanent magnets 18 is less likely to flow to the rotary shaft 20. Thus, the magnetic flux leakage to the rotary shaft 20 can be reduced. In addition, the rotation of the rotor 1B can be stabilized because the second cores 10B on both ends in the axial direction of the rotor 1B are fixed to the rotary shaft 20.

### Fourth Embodiment

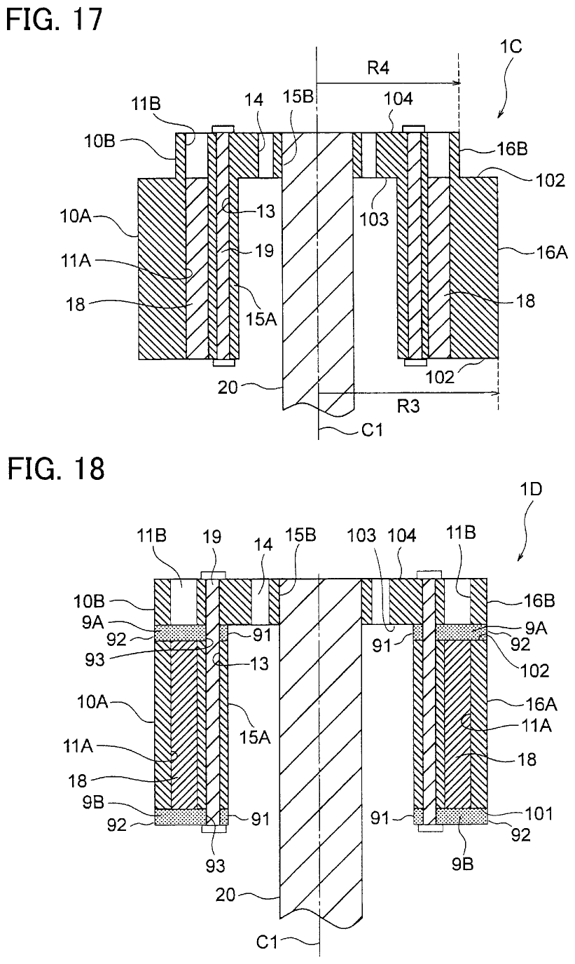

FIG. 17 is a longitudinal-sectional view illustrating a rotor 1C of a motor of a fourth embodiment. The rotor 1C of the fourth embodiment differs from the motor 6 of the first embodiment in that the outer diameter of the second core 10B is smaller than that of the first core 10A.

In the rotor 1C, a distance R4 from the central axis C1 to the outer circumference 16B of the second core 10B is smaller than a distance R3 from the central axis C1 to the outer circumference 16A of the first core 10A. In other words, the outer diameter of the second core 10B is smaller than the outer diameter of the first core 10A.

The second core 10B has the slit holes 11B communicating with the magnet insertion holes 11A of the first core 10A. The magnet insertion holes 11A and the slit holes 11B are as described in the first embodiment. It is also possible to provide the magnet insertion holes and the slit holes described in the first to fourth modifications.

The motor of the fourth embodiment is configured in a similar manner to the motor 6 of the first embodiment in other respects.

In the motor of the fourth embodiment, the outer diameter of the second core 10B is smaller than the outer diameter of the first core 10A, and thus the area of portions serving as the magnetic paths in the second core 10B is small. Thus, the magnetic flux is less likely to flow from the second core 10B to the rotary shaft 20, and therefore the effect of reducing the magnetic flux leakage to the rotary shaft 20 can be enhanced.

In the motors (FIGS. 15 and 16) of the second and third embodiments, the outer diameter of the second core 10B may be smaller than the outer diameter of the first core 10A.

### Fifth Embodiment

FIG. 18 is a longitudinal-sectional view illustrating a rotor 1D of a motor of a fifth embodiment. The rotor 1D of the fifth embodiment differs from the motor 6 of the first embodiment in that an end plate 9A is disposed between the first core 10A and the second core 10B.

The end plate 9A is disposed between the second end surface 102 of the first core 10A and the first end surface 103 of the second core 10B. The end plate 9A is annular and has an inner circumference 91 and an outer circumference 92. In the example illustrated in FIG. 18, the inner circumference 91 of the end plate 9A is located at the same position in the radial direction as the inner circumference of the hole portion 15A of the first core 10A, and the outer circumference 92 of the end plate 9A is located at the same position in the radial direction as the outer circumference 16A of the first core 10A.

In this regard, the inner circumference 91 and the outer circumference 92 of the end plate 9A may not necessarily be located at the positions described above. That is, the end plate 9A may cover at least the end in the axial direction of the magnet insertion hole 11A of the first core 10A.

The end plate 9A also has through holes 93 located at the positions corresponding to the through holes 13 of the first core 10A and the second core 10B. The first core 10A, the second core 10B, and the end plate 9A are fastened together by the rivets 19 inserted through the through holes 13 and the through holes 93.

The end plate 9A is made of a nonmagnetic material such as stainless steel. Since the end plate 9A which is a nonmagnetic member is disposed between the first core 10A and the second core 10B, the flow of the magnetic flux of the permanent magnets 18 to the second core 10B is suppressed. As a result, the effect of reducing the magnetic flux leakage to the rotary shaft 20 can be enhanced.

Another end plate 9B may be provided on the end surface 101 of the first core 10A on the side opposite to the second core 10B. The shape and material of the end plate 9B are the same as those of the end plate 9A. The end plate 9B is fixed to the first core 10A by the rivets 19.

The motor of the fifth embodiment is configured in a similar manner to the motor 6 of the first embodiment in other respects.

In the fifth embodiment, the flow of the magnetic flux of the permanent magnets 18 to the second core 10B is suppressed because the nonmagnetic end plate 9A is disposed between the first core 10A and the second core 10B. Thus, the effect of reducing the magnetic flux leakage to the rotary shaft 20 can be enhanced.

In addition, since the end plates 9A and 9B are disposed on both sides in the axial direction of the first core 10A, the permanent magnets 18 can be prevented from falling out of the magnet insertion hole 11A.

Incidentally, in the motors (FIGS. 15 to 17) of the second to fourth embodiments described above, the end plate 9A may be provided between the first core 10A and the second core 10B.

### Modification

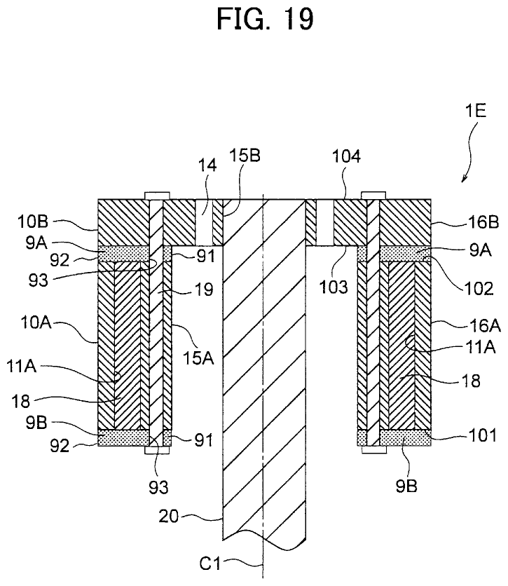

FIG. 19 is a longitudinal-sectional view illustrating a rotor 1E of a modification of the fifth embodiment. The rotor 1E differs from the rotor 1D of the fifth embodiment in that the second core 10B does not have the slit hole 11B (FIG. 18).

In this modification, the second core 10B does not have the slit hole 11B. However, the nonmagnetic end plate 9A is disposed between the first core 10A and the second core 10B as described above, and thus the flow of the magnetic flux of the permanent magnets 18 to the second core 10B can be suppressed. Thus, the magnetic flux leakage to the rotary shaft 20 can be reduced.

Further, since it is not necessary to form the slit holes 11B in the second core 10B, the manufacturing process can be simplified and the manufacturing cost can be reduced.

The motor of this modification is configured in a similar manner to the motor of the fifth embodiment in other respects.

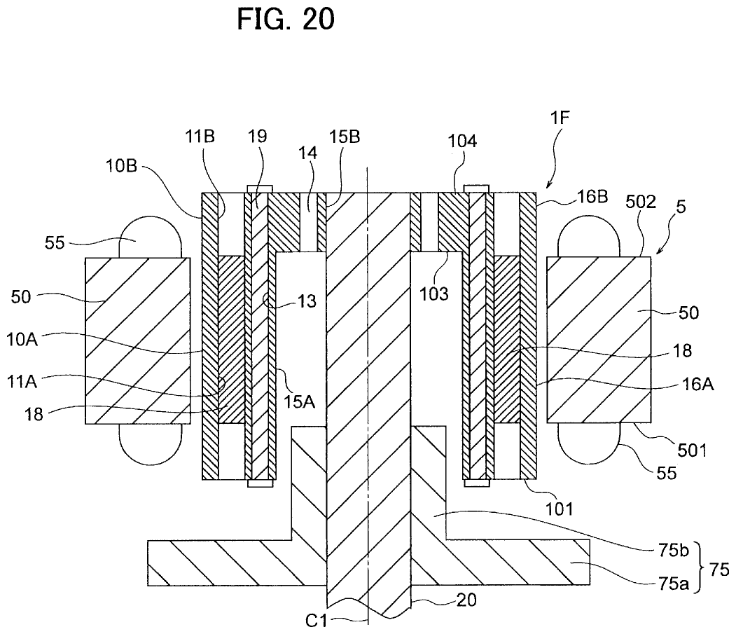

The respective embodiments and modification described above can be modified as appropriate. For example, in the rotor 1 illustrated in FIG. 2, the first end surface 101 of the first core 10A is located at the same position in the radial direction as the first end surface 501 of the stator core 50, but the first core 10A may protrude from the stator core 50 toward the compression mechanism 7 side as in a rotor 1F illustrated in FIG. 20.

In this case, a part of the bearing portion 75b of the main bearing 75 in the compression mechanism 7 can be located inside the hole portion 15A of the first core 10A. In this regard, in a region of the first core 10A facing the bearing portion 75b in the radial direction, the permanent magnets 18 are not disposed in the magnet insertion holes 11A.

That is, the permanent magnets 18 are located between both end surfaces 501 and 502 of the stator core 50 in the axial direction. This can prevent the magnetic flux of the permanent magnets 18 from affecting the bearing portion 75b formed of the magnetic material.

In the above-described embodiments and modifications, the through holes 13 and the air holes 14 are provided in the rotor. However, it is also possible to employ a configuration in which one or both of the through hole 13 and the air hole 14 is not provided.

### (Refrigeration Cycle Apparatus)

Next, a refrigeration cycle apparatus to which the compressor 8 of each embodiment is applicable will be described. FIG. 21 is a diagram illustrating the configuration of the refrigeration cycle apparatus 200. The refrigeration cycle apparatus 200 illustrated in FIG. 21 is an air conditioner in this example. However, the refrigeration cycle apparatus 200 is not limited to the air conditioner, and may be a refrigerator, a heat pump cycle apparatus, or the like.

The refrigeration cycle apparatus 200 includes the compressor 8 of the first embodiment, a four-way valve 201 as a switching valve, an outdoor heat exchanger 202, a decompression device 203, an indoor heat exchanger 204, and a refrigerant pipe 205.

The compressor 8, the four-way valve 201, the outdoor heat exchanger 202, the decompression device 203, and the indoor heat exchanger 204 are connected together by the refrigerant pipe 205 to configure a refrigerant circuit. The refrigeration cycle apparatus 200 further includes an outdoor fan 206 facing the outdoor heat exchanger 202 and an indoor fan 207 facing the indoor heat exchanger 204.

It is desirable to use a refrigerant containing an ethylene-based hydrofluorocarbon as the refrigerant. For example, it is desirable to use 1,1,2-trifluoroethylene (R1123). However, the refrigerant is not limited thereto, and other kinds of ethylene-based hydrofluorocarbons may be used. A mixture of two or more kinds of ethylene-based hydrofluorocarbons may be used.

Specifically, a mixture of 1,1,2-trifluoroethylene (R1123) and difluoromethane (R32) can be used. The mixture desirably contains 40 to 60 weight percent of R1123 and the remaining weight percent of R32. Alternatively, one or both of R1123 and R32 may be replaced with another substance. R1123 may be replaced with another ethylene-based hydrofluorocarbon or may be replaced with a mixture of R1123 and another ethylene-based hydrofluorocarbon.

As other examples of ethylene-based hydrofluorocarbons, it is possible to use fluoroethylene (R1141), 1,1-difluoroethylene (R1132a), trans-1,2-difluoroethylene (R1132(E)), and cis-1,2-difluoroethylene (R1132(Z)).

R32 may be replaced with, for example, any one of 2,3,3,3-tetrafluoropropene (R1234yf), trans-1,3,3,3-tetrafluoropropene (R1234ze(E)), cis-1,3,3,3-tetrafluoropropene (R1234ze(Z)), 1,1,1,2-tetrafluoroethane (R134a), and 1,1,1,2,2-pentafluoroethane (R125).

R32 may be replaced with, for example, a mixture composed of two or more of R32, R1234yf, R1234ze(E), R1234ze(Z), R134a, and R125.

R1123 may be replaced with another ethylene-based hydrofluorocarbon or a mixture of R1123 and another ethylene-based hydrofluorocarbon.

The operation of the refrigeration cycle apparatus 200 is as follows. The compressor 8 compresses the sucked refrigerant and discharges the compressed refrigerant as a high-temperature and high-pressure gas refrigerant. The four-way valve 201 switches the flow direction of the refrigerant. In a cooling operation, the refrigerant discharged from the compressor 8 flows to the outdoor heat exchanger 202 as illustrated by a solid line in FIG. 21.

The outdoor heat exchanger 202 operates as a condenser. The outdoor heat exchanger 202 exchanges heat between the refrigerant discharged from the compressor 8 and outdoor air supplied by the outdoor fan 206 to condense the refrigerant and then discharges the condensed refrigerant as a liquid refrigerant. The decompression device 203 decompresses the liquid refrigerant discharged from the outdoor heat exchanger 202. Consequently, the refrigerant is brought into a two-phase mixed state of the low-temperature and low-pressure gas refrigerant and the low-temperature and low-pressure liquid refrigerant.

The indoor heat exchanger 204 operates as an evaporator. The indoor heat exchanger 204 exchanges heat between the refrigerant in the two-phase mixed state and indoor air to evaporate the refrigerant and then discharges the evaporated refrigerant as a single-phase gas refrigerant. Air from which the heat is removed in the indoor heat exchanger 204 is supplied by the indoor fan 207 to the interior of a room, which is a space to be air-conditioned.

During a heating operation, the four-way valve 201 delivers the refrigerant discharged from the compressor 8 to the indoor heat exchanger 204. In this case, the indoor heat exchanger 204 functions as the condenser, while the outdoor heat exchanger 202 functions as the evaporator.

In the compressor 8 of the refrigeration cycle apparatus 200, the magnetic flux leakage to the rotary shaft 20 is suppressed as described in the first embodiment, and thus it is possible to suppress the adsorption of wear debris caused by the magnetization of the compression mechanism 7. Further, the outflow of the refrigerant oil to the outside of the compressor 8 can also be suppressed. Thus, the reliability of the refrigeration cycle apparatus 200 can be enhanced, and the operating efficiency of the refrigeration cycle apparatus 200 can be improved.

Instead of the compressor of the first embodiment, a compressor having the motor of any of the second to fifth embodiments and respective modifications may be used.

Although the desirable embodiments have been specifically described above, various modifications and changes can be made based on the above-described embodiments.

1. A motor used in a compressor, comprising:
a rotor including a rotor core fixed to a rotary shaft of the compressor, and a permanent magnet fixed to the rotor core; and
a stator including a stator core surrounding the rotor core from outside in a radial direction about a central axis of the rotary shaft,
wherein the rotor core has a first core and a second core in a direction of the central axis,
wherein the first core has a hole portion at a center thereof in the radial direction, and has a magnet insertion hole located on an outer side of the hole portion in the radial direction, the permanent magnet being inserted in the magnet insertion hole, the permanent magnet constituting a magnet magnetic pole, and a part of the first core constituting a pseudo magnetic pole,
wherein the second core has a shaft hole at a center thereof in the radial direction, the rotary shaft being fixed to the shaft hole,
wherein an inner circumference of the hole portion of the first core is distanced from the rotary shaft in the radial direction,
wherein the second core is located on an outer side of the stator core in the direction of the central axis, and
wherein the second core is not in contact with the permanent magnet.

2. The motor according to claim 1, wherein the second core has a slit hole communicating with the magnet insertion hole of the first core.

3. The motor according to claim 2, wherein the magnet insertion hole has a length W1 in a circumferential direction about the central axis and a width Ti in the radial direction,
wherein the slit hole has a length T1 in the circumferential direction and a width T2 in the radial direction, and
wherein W2≥W1 and T2≥T1 are satisfied.

4. The motor according to claim 3, wherein a distance from the central axis to an outer circumference of the first core is equal to a distance from the central axis to an outer circumference of the second core, and
wherein W2=W1 and T2=T1 are satisfied.

5. The motor according to claim 1, wherein a distance from the center axis to an outer circumference of the first core is longer than a distance from the center axis to an outer circumference of the second core.

6. The motor according to claim 1, wherein the first core has a length L1 in the direction of the central axis,
wherein the second core has a length L2 in the direction of the central axis,
wherein the stator core has a length Ls in the direction of the central axis, and
wherein L1≥Ls>L2 are satisfied.

7. The motor according to claim 1, wherein the rotor core has a through hole passing through the first core and the second core in the direction of the central axis.

8. The motor according to claim 7, wherein the rotor has a rivet in the through hole to fix the first core and the second core to each other.

9. The motor according to claim 8, wherein the rivet is made of a nonmagnetic material.

10. The motor according to claim 1, wherein the second core has a plurality of openings around the shaft hole.

11. The motor according to claim 10, wherein at least one of the plurality of openings communicates with a cavity portion inside the hole portion of the first core.

12. The motor according to claim 1, wherein a distance R1 from the central axis to an inner circumference of the hole portion of the first core, a distance R2 from the central axis to an inner circumference of the shaft hole of the second core, and a distance R3 from the central axis to an outer circumference of the first core satisfy:
0.41≤(R1−R2)/(R3−R1)≤0.72.

13. The motor according to claim 12, wherein 0.50≤(R1−R2)/(R3−R1)≤0.65 is further satisfied.

14. The motor according to claim 1, wherein the first core and the second core are in contact with each other.

15. The motor according to claim 1, wherein a nonmagnetic member is provided between the first core and the second core.

16. The motor according to claim 1, wherein the first core is located between the second core and a compression mechanism of the compressor in the direction of the central axis.

17. The motor according to claim 16, wherein the first core protrudes from the stator core toward the compression mechanism side.

18. The motor according to claim 1, wherein the second core is located between the first core and a compression mechanism of the compressor in the direction of the central axis.

19. The motor according to claim 1, wherein the second core is located on each of both sides of the first core in the direction of the central axis.

20. A compressor comprising:
the motor according to claim 1; and
a compression mechanism to be driven by the motor.

21. A refrigeration cycle apparatus comprising the compressor according to claim 20, a condenser, a decompression device, and an evaporator.
